(19) United States
(12) Patent Application Publication
(10) Pub. No.: US 2009/0301325 A1
(43) Pub. Date: Dec. 10, 2009

(54) Raised ultraviolet printing process

(76) Inventor: John M. Giusto, Branford, CT (US)

Correspondence Address: CANTOR COLBURN, LLP, 20 Church Street, 22nd Floor, Hartford, CT, 06103, US

(21) Appl. No.: 11/786,993

(22) Filed: Apr. 12, 2007

Related U.S. Application Data
(60) Provisional application No. 60/791,616, filed on Apr. 12, 2006.

(51) Int. Cl. B41M 1/10

(52) U.S. Cl. 101/170

(57) ABSTRACT

A method and a system of printing and an article printed thereby, where the method includes providing a substrate, applying a first stampable ultraviolet coating to the substrate, drying the first stampable ultraviolet coating, applying a second stampable ultraviolet coating to the substrate on top of the first stampable ultraviolet coating, drying the second stampable ultraviolet coating, and forming raised, light refractive portions of the first and second stampable ultraviolet coatings on the substrate.

### CROSS REFERENCE TO RELATED APPLICATION

This application is related to and claims the benefit of U.S. Provisional Patent Application Ser. No. 60/791,616 filed on 12 Apr. 2006, the entire contents of which are herein incorporated by reference.

### TECHNICAL FIELD OF INVENTION

The invention concerns a method and a system of printing and, more particularly, a ultraviolet printing process which results in a raised print which reflects and/or refracts incident light to give an attractive specular property to the printed media.

### BACKGROUND OF INVENTION

Embossed printing techniques, and particularly micro-embossing techniques, are used in the printing industry to provide raised printed surfaces. Such micro-embossing is often applied to packaging cartons in order to provide the cartons with an attractive appearance. In the retail industry at least, visual attraction of packaged goods is of particular importance in attaining a customer's attention and in securing their eventual purchase of the goods. Sophisticated micro-embossed printing may indeed draw a consumer to a particular packaged good and, further, aid the consumer in distinguishing and ultimately purchasing the embossed packaged good relative to a competing product.

However, micro-embossed printing of packaging cartons can involve a complex, time consuming, and/or expensive process. Additionally, micro-embossing simply provides a printed surface in relief but leaves the print with a flat, non-reflective, non-refractive appearance.

Accordingly, what is needed is a printing process for adorning packaging cartons and the like with a printed pattern which is raised from the printing surface and is reflective and/or refractive in order to provide a dramatic eye-catching appeal, where the printing process is simple and expedient and can be provided at a reduced cost.

### BRIEF SUMMARY OF THE INVENTION

The invention provides a method of printing including providing a substrate, applying a first stampable ultraviolet coating to the substrate, drying the first stampable ultraviolet coating, applying a second stampable ultraviolet coating to the substrate on top of the first stampable ultraviolet coating, drying the second stampable ultraviolet coating, and forming raised, light refractive portions of the first and second stampable ultraviolet coatings on the substrate.

In another embodiment, the invention provides a printing press system, comprising a first coating device configured to provide a first print coating to a substrate, a second coating device configured to provide a second print coating to a substrate atop the first print coating, a drying device configured to dry the first print coating prior to application of the second print coating and further configured to dry the second print coating, where the first and second coating devices and the drying device are further configured to provided a raised printed pattern on the substrate wherein the pattern includes light refractive portions.

In further embodiment of the invention, a printed substrate is provided as comprising a first print layer formed on the substrate, a second print layer formed on the first print layer, and protrusions of the first and/or second print layers extending from the substrate, where the protrusions include light-refractive portions.

The above-discussed and other features and advantages of the apparatus and method will be appreciated and understood by those skilled in the art from the following drawings and detailed description.

### BRIEF DESCRIPTION OF THE FIGURES

FIG. 1 is a perspective is a block diagram of an exemplary process of the invention.

### DETAILED DESCRIPTION OF THE PREFERRED EMBODIMENT

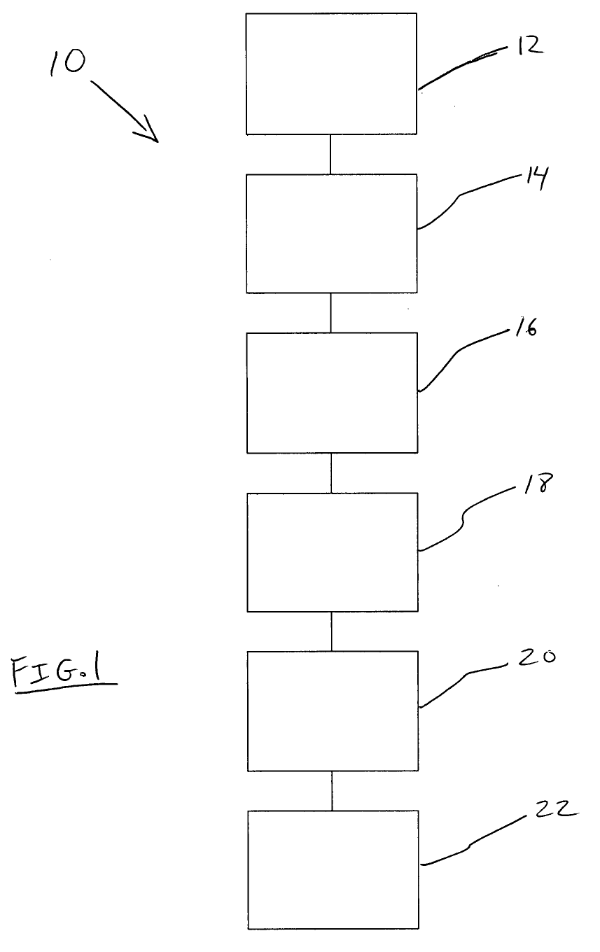

FIG. 1 shows a block diagram which represents an exemplary embodiment of the invention. Namely, FIG. 1 shows a raised ultraviolet (UV) printing process 10. At an initial step of the process 12 a substrate is provided. The substrate is, for example, paper or cardboard or the like and may be of any desired shape and thickness. At item 12, the substrate may be cut, shaped, etc., or this may be performed previous to step 12. At item 14, a first coat of print material is applied to the substrate. The first coat is preferably a stampable UV coating applied with an anilox flexo coater. For example, a 120 line screen anilox is used in the first coater. Once the first coating is applied, the substrate is subjected to a drying element at 16. Interstation UV lamps are used to dry the first coating. Particularly, three interstation UV lamps are operated at approximately 65% power to dry the first print coating on the substrate. A second coat of print material is then applied at 18 to the substrate atop the first print coating. Here, a second coater is utilized including an 80 line screen anilox to apply the second print coating which comprises a second UV stampable coating. The substrate is then subjected to further drying at 20. Here, for example, three interstation UV lamps are operated at approximately 70% power in order to dry the second print coating. After drying at 20, the substrate may then be optionally subjected to final processing such as, for example, cutting, shaping, folding, glossing, packaging, etc.

The UV printing process 10 is performed, in this exemplary embodiment, on a lithographic printing press equipped with two anilox flexo coaters and UV drying means. The process 10 may be carried out, for example, on a printing press known by the brand name of KBA Rapida. Here, the printing press is a fifty-one inch model and is equipped with a unique combination of inline coaters and drying systems such that the press is readily configured to apply a wide variety of special effects to the substrate in a single pass.

The printing process 10 results in two UV coatings disposed atop one another on a substrate. This results in a print image being raised above the substrate so as to provide a tactile relieve feel. Also, the layering of the first and second UV coatings creates relief areas which reflect and/or refract light incident upon the substrate. This gives the printed image a sparkling, shimmering, specular appearance.

The printing process 10 can be applied in copy, a unique pattern, or an overall finish. It can also be laid down in different levels of texture.

It shall be understood that the description of the printing process 10 as including two coating procedures 14 and 18 and two respective drying procedures 16 and 20 is merely exemplary. The invention, more generally, comprises the application of a plurality of UV print coatings to a substrate and the application of drying and/or curing procedures with respect to the plurality of coatings in order to create multiple overlapping UV print coatings on a substrate so as to provide a print image in relief with light refracting properties.

It shall further be understood that the invention extends to the system described above for applying the printing process to the substrate. The invention further extends to the substrate subjected to the printing process 10 and including the above-discussed multiple UV coatings.

The printing process of the invention thus provides the rich feel and texture of micro-embossing but yet is performed on a press without requiring any additional offline time consuming embossing processes and without the need for embossing dies. The process 10 provides embossed-like effects for a fraction of the cost associated with embossing and additionally provides a visually attractive light reflecting luminance.

It will be apparent to those skilled in the art that, while exemplary embodiments have been shown and described, various modifications and variations can be made to the present apparatus and method disclosed herein without departing from the spirit or scope of the invention. Accordingly, it is to be understood that the various embodiments have been described by way of illustration and not limitation.

1. A method of printing, comprising:
providing a substrate;
applying a first stampable ultraviolet coating to the substrate;
drying the first stampable ultraviolet coating;
applying a second stampable ultraviolet coating to the substrate on top of the first stampable ultraviolet coating;
drying the second stampable ultraviolet coating; and
forming raised, light refractive portions of the first and second stampable ultraviolet coatings on the substrate.

2. The method of claim 1, wherein the first stampable coating is applied with a anilox flexo coater having an approximate 120 line screen anilox.

3. The method of claim 1, wherein the second stampable coating is applied with a anilox flexo coater having an approximate 80 line screen anilox.

4. The method of claim 1, wherein drying the first stampable ultraviolet coating comprises exposing the substrate to a plurality of interstation ultraviolet lamps operating at about 65% power.

5. The method of claim 4, wherein drying the second stampable ultraviolet coating comprises exposing the substrate to a plurality of interstation ultraviolet lamps operating at about 70% power.

6. The method of claim 5, wherein the plurality of interstation ultraviolet lamps comprises approximately three said lamps.

7. The method of claim 1, wherein said applying is performed on a lithographic printing press.

8. The method of claim 1, wherein said providing a substrate comprises providing a packaging carton or a portion thereof.

9. A printing press system, comprising:
a first coating device configured to provide a first print coating to a substrate;
a second coating device configured to provide a second print coating to a substrate atop the first print coating;
a drying device configured to dry the first print coating prior to application of the second print coating and further configured to dry the second print coating; and
wherein the first and second coating devices and the drying device are further configured to provided a raised printed pattern on the substrate wherein the pattern includes light refractive portions.

10. The system of claim 9, wherein the first and second coating devices each comprise anilox flexo coater.

11. The system of claim 10, wherein the first coating device includes an approximate 120 line screen anilox and the second coating device includes an approximate 80 line screen anilox.

12. The system of claim 9, wherein the drying device comprises approximately three interstation ultraviolet lamps configured to operate at about 65% power to dry the first print coating and at about 70% power to dry the second print coating.

13. A printed substrate, comprising:
a first print layer formed on the substrate;
a second print layer formed on the first print layer; and
protrusions of the first and/or second print layers extending from the substrate;
wherein the protrusions include light-refractive portions.

14. The substrate of claim 13, wherein the first and second print layers each comprise a stampable ultraviolet coating.
